(19) United States
(12) Patent Application Publication
(10) Pub. No.: US 2022/0188399 A1
(43) Pub. Date: Jun. 16, 2022

(54) SERVICE PROVIDING SYSTEM, SERVICE PROVIDING METHOD, AND NON-TRANSITORY RECORDING MEDIUM

(71) Applicant: Yusuke Yoshioka, Kanagawa (JP)

(72) Inventor: Yusuke Yoshioka, Kanagawa (JP)

(73) Assignee: Ricoh Company, Ltd., Tokyo (JP)

(21) Appl. No.: 17/457,740

(22) Filed: Dec. 6, 2021

(30) Foreign Application Priority Data
Dec. 14, 2020 (JP) 2020-206591

(51) Int. Cl. G06F 21/44; G06F 9/50

(52) U.S. Cl. CPC G06F 21/44; G06F 9/5083

(57) ABSTRACT

A service providing system, a service providing method, and a program stored in a non-transitory recording medium, each controls execution of a workflow defining a plurality of processes; in response to an occurrence of an authentication error in a predetermined process authenticated by an authentication server among the plurality of processes of the workflow, controlling updating of authentication information corresponding to the predetermined process, while suspending the execution of the workflow; and resumes the execution of the workflow based on completion of the updating of the authentication information.

### CROSS-REFERENCE TO RELATED APPLICATIONS

This patent application is based on and claims priority pursuant to 35 U.S.C. § 119(a) to Japanese Patent Application No. 2020-206591, filed on Dec. 14, 2020, in the Japan Patent Office, the entire disclosure of which is hereby incorporated by reference herein.

### BACKGROUND

### Technical Field

The present disclosure relates to a service providing system, a service providing method, and a non-transitory recording medium.

### Description of the Related Art

Recently, various external services are provided via cloud computing or the like. For example, a service providing system may be provided in which a device performs a series of processes in cooperation with such external services in accordance with a workflow in which the plurality of processes is defined.

The service providing system may change an authentication service for authenticating a process included in a workflow.

### SUMMARY

Example embodiments include a service providing system including circuitry that controls execution of a workflow defining a plurality of processes. In response to an occurrence of an authentication error in a first process authenticated by an authentication server among the plurality of processes of the workflow, the circuitry controls updating of authentication information corresponding to the first process, while suspending the execution of the workflow, and resumes the execution of the workflow based on completion of the updating of the authentication information.

Example embodiments include a service providing apparatus including circuitry that controls execution of a workflow defining a plurality of processes. In response to an occurrence of an authentication error in a first process authenticated by an authentication server among the plurality of processes of the workflow, the circuitry controls updating of authentication information corresponding to the first process, while suspending the execution of the workflow, and resumes the execution of the workflow based on completion of the updating of the authentication information.

Example embodiments include a service providing method comprising: controlling execution of a workflow defining a plurality of processes; in response to an occurrence of an authentication error in a predetermined process authenticated by an authentication server among the plurality of processes of the workflow, controlling updating of authentication information corresponding to the predetermined process, while suspending the execution of the workflow; and resuming the execution of the workflow based on completion of the updating of the authentication information.

Example embodiments include a non-transitory recording medium which, when executed by one or more processors, cause the processors to perform a service providing method including: controlling execution of a workflow defining a plurality of processes; in response to an occurrence of an authentication error in a predetermined process authenticated by an authentication server among the plurality of processes of the workflow, controlling updating of authentication information corresponding to the predetermined process, while suspending the execution of the workflow; and resuming the execution of the workflow based on completion of the updating of the authentication information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of a system configuration of an information processing system according to embodiments;

FIG. 2 is a block diagram illustrating an example of a hardware configuration of a computer according to embodiments;

FIG. 3 is a block diagram illustrating an example of a hardware configuration of an image forming apparatus according to embodiments;

FIG. 4 is a block diagram illustrating an example of a functional configuration of the information processing system according to embodiments;

FIG. 5 is a block diagram illustrating an example of a functional configuration of a logic processing unit according to a first embodiment;

FIG. 6 is a sequence diagram illustrating an example of a process performed by an information processing system according to the first embodiment;

FIG. 7 is a diagram illustrating an example of workflow information according to the first embodiment;

FIGS. 8A to 8C are schematic diagrams for describing an example of a workflow according to the first embodiment;

FIG. 9 is a block diagram illustrating an example of a functional configuration of a logic processing unit according to a second embodiment;

FIG. 10 is a sequence diagram illustrating an example of a process performed by an information processing system according to the second embodiment;

FIG. 11 is another sequence diagram illustrating the example of the process performed by the information processing system according to the second embodiment;

FIG. 12 is a schematic diagram for describing an example of a workflow according to the second embodiment;

FIG. 13 is a block diagram illustrating an example of a functional configuration of a logic processing unit according to a third embodiment;

FIG. 14 is a schematic diagram illustrating an example of authentication server information according to the third embodiment;

FIG. 15 is a block diagram illustrating an example of a functional configuration of an information processing system according to the third embodiment; and

FIGS. 16A and 16B are schematic diagrams for describing an example of a workflow according to the third embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise.

### System Configuration

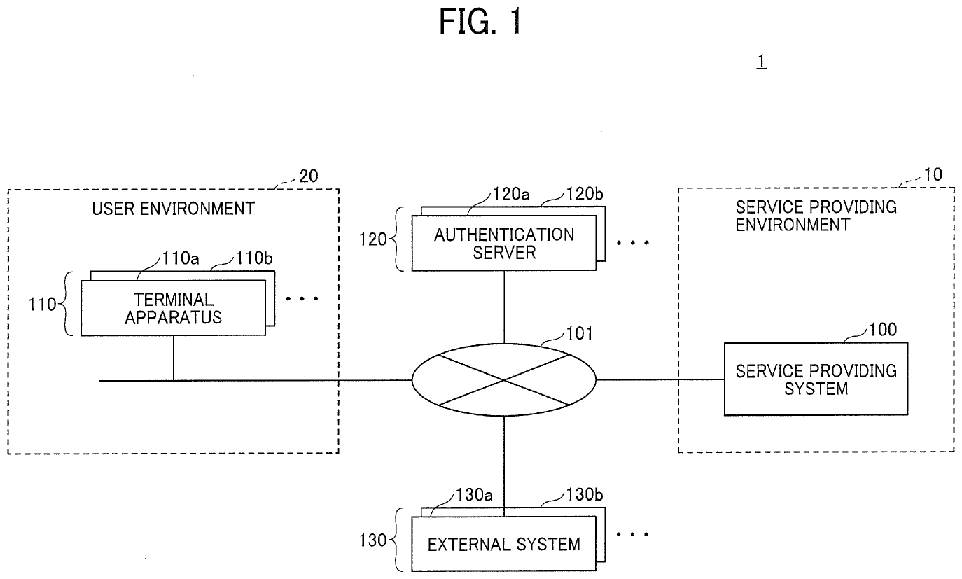

FIG. 1 is a schematic diagram illustrating an example of a system configuration of an information processing system according to embodiments. In an information processing system 1, for example, a service providing environment 10; a user environment 20; one or more authentication servers 120a, 120b, . . . ; and one or more external systems 130a, 130b, are connected to one another via a communication network 101 to be communicable with one another. In the description below, the term “authentication server 120” is used to refer to any of the one or more authentication servers 120a, 120b, . . . . In addition, the term “external system 130” is used to refer to any of the one or more external systems 130a, 130b, . . . .

The user environment 20 is, for example, a system environment, such as an intra-company network, including one or more terminal apparatuses 110a, 110b, . . . used by users of the service providing environment 10. In the description below, the term “terminal apparatus 110” is used to refer to any of the one or more terminal apparatuses 110a, 110b, . . . .

The terminal apparatus 110 is, for example, an information terminal, such as a personal computer (PC), a smartphone, or a tablet terminal, having a web browser function; or an electronic device, such as an image forming apparatus, a projector, or an interactive white board (IWB), having a web browser function.

The service providing environment 10 is, for example, a system environment that provides services such as cloud services via the communication network 101 such as the Internet or a local area network (LAN). In the present embodiment, the services provided by the service providing environment 10 are not limited to cloud services and may be various services such as services or web services provided by an application service provider (ASP), for example.

The service providing environment 10 includes at least a service providing system 100. The service providing system (service providing apparatus) 100 includes, for example, an information processing apparatus implemented by a computer or by a plurality of computers. In response to a request from, for example, the terminal apparatus 110 or the like, the service providing system 100 performs a series of processes based on a workflow in which the plurality of processes are defined.

A workflow is, for example, information that defines a series of processes in which a plurality of components, which perform predetermined processes such as an input process, a conversion process, and an output process on electronic data that serves as a processing target, are combined. A component is a program that performs a corresponding process included in a workflow. For example, in response to a processing request from the terminal apparatus 110, the service providing system 100 performs various processes such as enlargement, reduction, file conversion, optical character recognition (OCR), and translation that are defined in a workflow on an electronic file and outputs the resulting electronic file to a predetermined output destination.

Note that the services provided by the service providing system 100 are not limited to this. The service providing system 100 may provide, for example, a service (cloud printing service) for printing an electronic file stored in the external system 130 or the like with the image forming apparatus, which is an example of the terminal apparatus 110 in the user environment 20. The service providing system 100 may also provide, for example, a service for projecting an electronic file stored in the external system 130 or the like with a projector, which is an example of the terminal apparatus 110 in the user environment 20.

The authentication server 120 functions as, for example, an authentication infrastructure that performs an authentication process for using a service provided by the external system 130. For example, in the case of using a service that requires authentication and that is provided by the external system 130a when executing a workflow, the service providing system 100 acquires authentication information (such as an access token) from the authentication server 120a corresponding to the external system 130a.

The external system 130 is, for example, a system including an information processing apparatus that provides various services such as a storage service via the communication network 101, or including a plurality of such information processing apparatuses. A storage service is a service for renting part or entirety of a storage area of the external system 130. The authentication server 120 according to the present embodiment functions as, for example, an authentication infrastructure for using a storage service provided by the external system 130 that serves as a storage destination of an electronic file in a workflow executed by the service providing system 100.

Part or entirety of the service providing system 100 may be provided in the user environment 20. One or more authentication servers 120 among the one or more authentication servers 120a, 120b, . . . may be provided in the service providing environment 10 or the user environment 20. One or more external systems 130 among the one or more external systems 130a, 130b, . . . may be provided in the service providing environment 10 (but outside the service providing system 100) or in the user environment 20.

When a plurality of services operate in cooperation with each other in the information processing system 1 described above, an authentication scheme based on OAuth or the like is used, for example. In OAuth, for example, the service providing system 100 uses authentication information called an access token to access a service provided by the external system 130 or the like. The access token has a period of validity. If the period of validity expires, the service providing system 100 uses a refresh token to refresh (update) the access token, and uses the refreshed access token to access the service provided by the external system 130 or the like.

In such an information processing system 1, different users may desire to use different authentication servers 120 (authentication infrastructures) (for example, a user A desires to use an external authentication infrastructure and a user B desires to use an in-house authentication infrastructure).

However, in the technique of the related art, a function of acquiring authentication information and a function of executing a workflow are separate. The technique of the related art thus has a disadvantage in that if an authentication error occurs during execution of a workflow, the execution of the workflow is not to be continued. Therefore, an information processing system of the related art is unable to perform a process whose processing time is longer than the period of validity of the access token, such as a process of processing many pages or a process of iterating uploading, for example.

Accordingly, the service providing system 100 according to the present embodiment has a function of, in response to an occurrence of an authentication error in a first process that is to be authenticated by the authentication server 120 during execution of a workflow, causing the authentication server 120 corresponding to the first process to update authentication information. The service providing system 100 also has a function of suspending the execution of the workflow in response to the occurrence of the authentication error in the first process during the execution of the workflow, and resuming the execution of the workflow based on the updating of the authentication information.

Consequently, according to the present embodiment, the service providing system 100 capable of changing an authentication service for processes included in a workflow is able to continue execution of the workflow even if an authentication error occurs during the execution of the workflow.

### Hardware Configuration

Hardware configurations of the apparatuses and the systems included in the information processing system 1 will be described next.

### Hardware Configurations of Service Providing System, Authentication Server, and External System

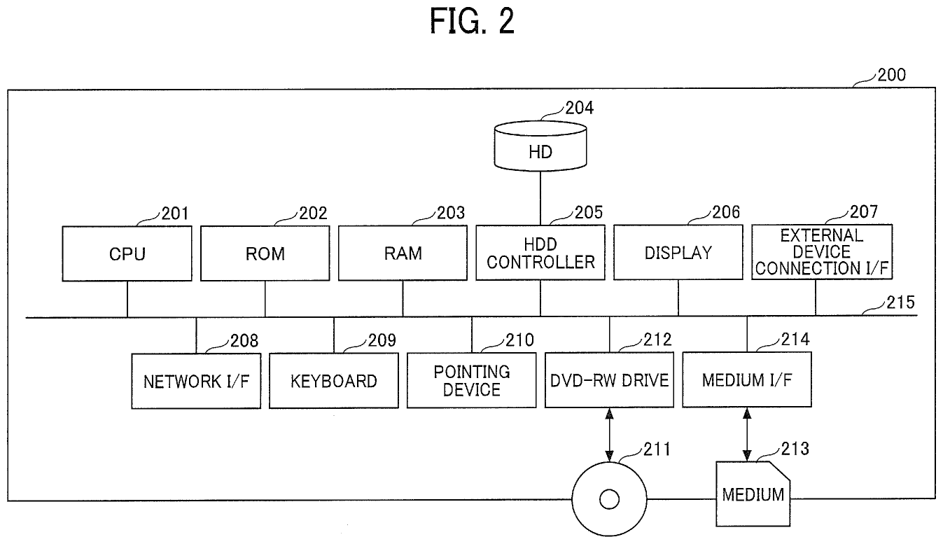

Each of the service providing system 100, the authentication server 120, and the external system 130 has, for example, a hardware configuration of a computer 200 illustrated in FIG. 2. In another example, each of the service providing system 100, the authentication server 120, and the external system 130 is constituted by the plurality of computers 200.

FIG. 2 is a block diagram illustrating an example of a hardware configuration of a computer according to one embodiment. As illustrated in FIG. 2, the computer 200 includes, for example, a central processing unit (CPU) 201, a read-only memory (ROM) 202, a random access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disc-rewritable (DVD-RW) drive 212, a medium I/F 214, and a bus line 215.

The CPU 201 controls operations of the entire computer 200. The ROM 202 stores, for example, a program used for booting the CPU 201, such as an initial program loader (IPL). The RAM 203 is used as a work area for the CPU 201. The HD 204 stores various kinds of data such as a program. The HDD controller 205 controls reading of various kinds of data from or writing of various kinds of data to the HD 204 under control of the CPU 201.

The display 206 displays various kinds of information such as a cursor, a menu, a window, characters, or an image. The external device connection I/F 207 is an interface that enables connection of various external devices. Examples of the external devices in this case include, for example, a Universal Serial Bus (USB) memory and a printer. The network I/F 208 is an interface that enables data communication via the communication network 101.

The keyboard 209 is an example of an input device equipped with a plurality of buttons with which characters, numerals, and various instructions are to be input, for example. The pointing device 210 is an example of an input device with which various instructions are selected or executed, a processing target is selected, and the cursor is moved, for example. The DVD-RW drive 212 controls reading of various kinds of data from or writing of various kinds of data to a DVD-RW 211, which is an example of a removable recording medium. The DVD-RW 211 may be another type of removable recording medium. The medium I/F 214 controls reading of data from or writing (storing) of data to a medium 213 such as a flash memory. The bus line 215 includes an address bus and a data bus that electrically connects the above-described components to one another and transfer various control signals or the like.

### Hardware Configuration of Terminal Apparatus

Description will be given of an example of a hardware configuration in the case where the terminal apparatus 110 is an image forming apparatus 300 such as a multifunction peripheral (MFP) having, for example, a scan function, a copy function, a print function, and a fax function in a single housing. Note that in the case where the terminal apparatus 110 is an information terminal such as a PC, the terminal apparatus 110 has, for example, the hardware configuration of the computer 200 illustrated in FIG. 2.

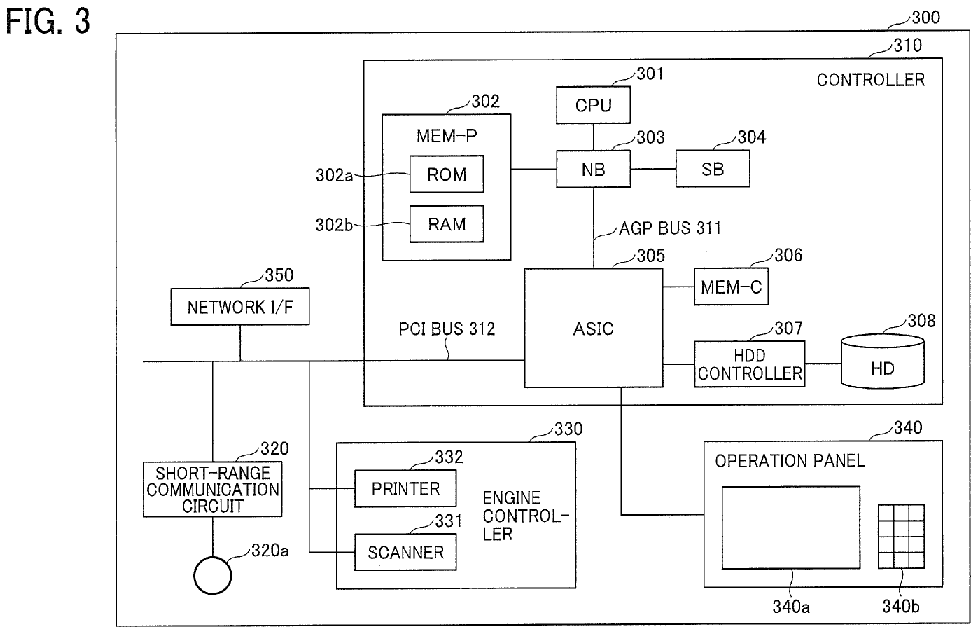

FIG. 3 is a block diagram illustrating an example of a hardware configuration of an image forming apparatus according to one embodiment. As illustrated in FIG. 3, the image forming apparatus 300 includes, for example, a controller 310, a short-range communication circuit 320, an engine controller 330, an operation panel 340, and a network I/F 350.

The controller 310 includes a CPU 301 as a main processor of the image forming apparatus, a system memory (MEM-P) 302, a north bridge (NB) 303, a south bridge (SB) 304, an application specific integrated circuit (ASIC) 305, a local memory (MEM-C) 306 as a storage, an HDD controller 307, and an HD 308 as a storage. The NB 303 and the ASIC 305 are connected to each other by an Accelerated Graphics Port (AGP) bus 311.

The CPU 301 is a controller that controls the entire image forming apparatus 300. The NB 303 is a bridge that connects the CPU 301 to the MEM-P 302, the SB 304, and the AGP bus 311. The NB 303 includes a memory controller that controls reading of data from or writing of data to the MEM-P 302, a Peripheral Component Interconnect (PCI) master, and an AGP target.

The MEM-P 302 includes a ROM 302a as a memory that stores a program and data for implementing each function of the controller 310. The MEM-P 302 also includes a RAM 302b used as a memory to which the program and data are loaded or as a rendering memory used at time of memory printing. The program stored in the RAM 302b may be recorded on any computer-readable recording medium, such as a compact disc-read only memory (CD-ROM), a compact disc-recordable (CD-R), or a digital versatile disc (DVD), as a file of an installable or executable format for distribution.

The SB 304 is a bridge that connects the NB 303 to a PCI device or a peripheral device. The ASIC 305 is an integrated circuit (IC) dedicated to an image processing use and including hardware components for image processing. The ASIC 305 has a role of a bridge that connects the AGP bus 311, a PCI bus 312, the HDD controller 307, and the MEM-C 306 to one another. The ASIC 305 includes a PCI target, an AGP master, an arbiter (ARB) as a central processor of the ASIC 305, a memory controller that controls the MEM-C 306, a plurality of direct memory access controllers (DMACs) that perform rotation on image data with a hardware logic or the like, and a PCI unit that transfers data to and from a scanner 331 and a printer 332 through the PCI bus 312. The ASIC 305 may be connected to a USB interface or an Institute of Electrical and Electronics Engineers (IEEE) 1394 interface.

The MEM-C 306 is a local memory used as a buffer for image data to be copied or as a code buffer. The HD 308 is a storage that stores image data, font data used in printing, and forms. The HDD controller 307 controls reading of data from or writing of data to the HD 308 under control of the CPU 301. The AGP bus 311 is a bus interface for a graphics accelerator card, which has been proposed to accelerate processing of graphics. By enabling a direct access to the MEM-P 302 at a high throughput, the AGP bus 311 can increase the speed of the graphics accelerator card.

The short-range communication circuit 320 includes, for example, a radio circuit that performs various types of short-range wireless communication via an antenna 320a for the short-range communication circuit 320, and a communication control circuit. The engine controller 330 includes, for example, the scanner 331 and the printer 332. The scanner 331 is a scanning device that scans a document or the like. The printer 332 is a printing device that prints an image based on print data on a printing medium. The scanner 331 or the printer 332 includes, for example, an image processor for error diffusion, gamma conversion, or the like.

The operation panel 340 includes a panel display 340a such as a touch panel, and operation buttons 340b. The panel display 340a displays a screen of current setting values, a selection screen, and so on and accepts an input from an operator. The operation buttons 340b include numeral buttons that accept setting values of image forming conditions such as color density setting conditions and a start button that accepts a copy start instruction. The controller 310 controls the entire image forming apparatus 300. For example, the controller 310 controls rendering, communication, and inputs from the operation panel 340.

An application switching button of the operation panel 340 enables sequential switching and selection of a document box function, a copy function, a print function, and a fax function of the image forming apparatus 300. When the document box function is selected, the image forming apparatus 300 enters a document box mode. When the copy function is selected, the image forming apparatus 300 enters a copy mode. When the print function is selected, the image forming apparatus 300 enters a printer mode. When the fax function is selected, the image forming apparatus 300 enters a fax mode.

The network I/F 350 is an interface that enables data communication via the communication network 101. The short-range communication circuit 320 and the network I/F 350 are electrically connected to the ASIC 305 through the PCI bus 312.

### Functional Configuration

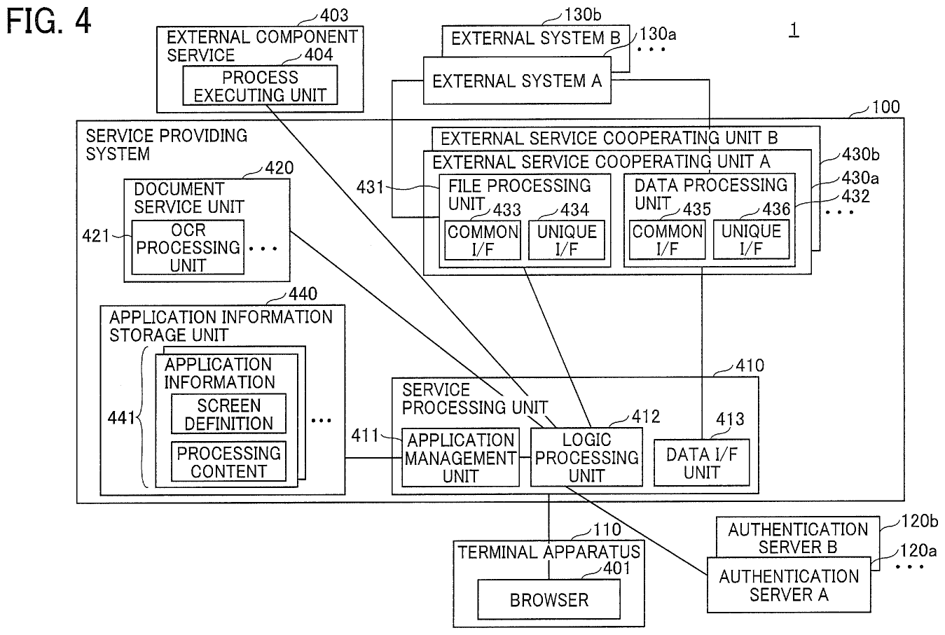

FIG. 4 is a block diagram illustrating an example of a functional configuration of the information processing system according to one embodiment. Description will be given of an example of the case where the information processing system 1 includes the service providing system 100; the terminal apparatus 110; the one or more authentication servers A 120a, B 120b, . . . ; the one or more external systems A 130a, B 130b, . . . ; and an external component service 403.

The one or more authentication servers A 120a, B 120b, . . . correspond to the one or more authentication servers 120 illustrated in FIG. 1. In the description below, the term “authentication server 120” is referred to any of the one or more authentication servers. The one or more external systems A 130a, B 130b, . . . correspond to the one or more external systems 130 illustrated in FIG. 1. In the description below, the term “external system 130” is used to refer to any of the one or more external systems.

### Functional Configuration of Service Providing System

The service providing system 100 includes a service processing unit 410, a document service unit 420, and external service cooperating units A 430a, B 430b, etc. Each of the functional units described above is implemented as a result of the CPU 201 or the like executing one or more programs that are installed on or downloaded to the service providing system 100. At least one of the functional units described above may be implemented by hardware. In the description below, the term “external service cooperating unit 430” is used to refer to any of the external service cooperating units A 430a, B 430b, . . . .

The service providing system 100 also includes an application information storage unit 440. The application information storage unit 440 is implemented by, for example, the HD 204 and the HDD controller 205 illustrated in FIG. 2. The application information storage unit 440 may be implemented by an external storage device or the like connected to the service providing system 100 via the communication network 101.

The service processing unit 410 includes, for example, an application management unit 411, a logic processing unit 412, and a data I/F unit 413.

The application management unit 411 manages application information 441 stored in the application information storage unit 440. In response to a request from a browser 401, the application management unit 411 returns an application screen based on a screen definition included in the application information 441. Consequently, the application screen that enables the use of a service provided by the service providing system 100 is displayed in the browser 401 of the terminal apparatus 110. The application information 441 is information describing the screen definition for use in displaying the application screen described above on the terminal apparatus 110, and processing content of a service implemented in accordance with the application information 441.

In response to a request from the logic processing unit 412, the application management unit 411 returns the processing content included in the application information 441. The processing content includes, for example, workflow information in which a plurality of processes is defined.

In response to a request from the browser 401, the logic processing unit 412 acquires the processing content from the application management unit 411. In accordance with the acquired processing content, the logic processing unit 412 then requests, for example, the authentication server 120, the document service unit 420, the external component service 403, and the external service cooperating unit 430 to perform a process. Consequently, the logic processing unit 412 executes the workflow in accordance with the request from the terminal apparatus 110. Detailed processing blocks of the logic processing unit 412 will be described later.

In response to a request from the browser 401, the data I/F unit 413 makes a predetermined request (for example, a request to acquire a folder list) to a data processing unit 432 of the external service cooperating unit 430.

The document service unit 420 includes, for example, one or more process executing units that perform some of a plurality of processes defined in a workflow. The document service unit 420 includes, for example, an OCR processing unit 421 that performs OCR processing on an electronic file. The document service unit 420 may include, for example, processing units that perform various processes such as a process of converting an electronic file into print data, a PDF, or the like and a process of compressing or decompressing an electronic file.

Some or all of the functions of the document service unit 420 may be performed using a process executing unit 404 of the external component service 403 that is external to the service providing system 100.

In response to a request from the logic processing unit 412 or the data I/F unit 413, the external service cooperating unit 430 requests the external system 130 to perform various processes. The service providing system 100 includes, for example, one external service cooperating unit 430 for each of the external systems 130. For example, the service providing system 100 includes the external service cooperating unit A 430a that requests the external system A 130a to perform a process, and the external service cooperating unit B 430b that requests the external system B 130b to perform a process.

The external service cooperating unit 430 includes, for example, a file processing unit 431 that accepts a request from the logic processing unit 412, and the data processing unit 432 that accepts a request from the data I/F unit 413.

The file processing unit 431 has a common I/F 433 and a unique I/F 434 for each of which an Application Programming Interface (API) for performing an operation (for example, acquisition, storage, or editing) on an electronic file stored in the external system 130 is defined. The common I/F 433 is an API that is usable in common by the plurality of external systems 130. In contrast, the unique I/F 434 is an API that is usable by a certain external system 130.

The data processing unit 432 has a common I/F 435 and a unique I/F 436 for each of which an API for acquiring metadata (for example, a file list or a folder list) such as bibliographic information of an electronic file stored in the external system 130 is defined. The common I/F 435 is an API that is usable in common by the plurality of external systems 130. In contrast, the unique I/F 436 is an API that is usable by a certain external system 130.

The application information storage unit 440 stores the application information 441. The application information 441 is information describing the screen definition for use in displaying the application screen on the terminal apparatus 110, and the processing content indicating a series of processes for implementing a service provided by the service providing system 100. The application information 441 is stored for each application identifier (ID) for uniquely identifying the application information 441 in the application information storage unit 440.

### First Embodiment

A functional configuration of the logic processing unit 412 according to a first embodiment will be described next.

### Functional Configuration of Logic Processing Unit

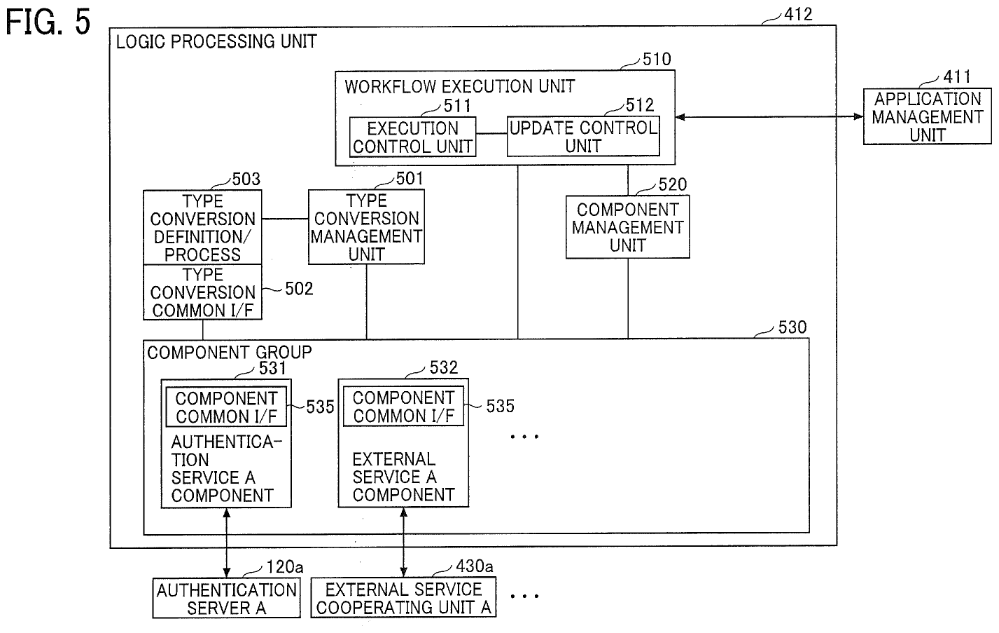

FIG. 5 is a block diagram illustrating an example of a functional configuration of the logic processing unit according to the first embodiment. The logic processing unit 412 includes, for example, a workflow execution unit 510, a component management unit 520, a component group 530, a type conversion management unit 501, a type conversion common I/F 502, and a type conversion definition/process 503.

The workflow execution unit 510 includes, for example, an execution control unit 511 and an update control unit 512. In response to a workflow execution request from the browser 401, the execution control unit 511 acquires the processing content (such as workflow information) from the application information 441 via the application management unit 411. In accordance with the acquired processing content, the execution control unit 511 controls execution of a plurality of processes included in the workflow.

In response to an occurrence of an authentication error in a process (hereinafter, referred to as a “first process”) that is to be authenticated by the authentication server 120 among the plurality of processes included in the workflow, the update control unit 512 controls updating of authentication information corresponding to the first process.

The workflow execution unit 510 according to the present embodiment has a function of suspending execution of the workflow in response to the occurrence of the error in the first process and of resuming the execution of the workflow when the update control unit 512 completes updating the authentication information. Specific processing content of the execution control unit 511 and the update control unit 512 will be described later.

The component management unit 520 generates a component in response to a request from the workflow execution unit 510. A component is a module (program) or the like that performs a corresponding process included in a workflow and is defined as, for example, a class or a function. The expression “generate a component” refers to, for example, loading a component defined as a class into a memory (for example, the RAM 203).

The component group 530 is a set of components. The component group 530 includes, for example, an authentication component that acquires authentication information for the external system 130 from the authentication server 120 (such as an authentication service A component 531 that acquires authentication information for the external system A 130a from the authentication server A 120a). The component group 530 also includes, for example, a distribution component that distributes (uploads) an electronic file to the external system 130 (such as an external service A component 532 that distributes an electronic file to the external system A 130a). The authentication component is defined for each of the authentication servers 120, for example.

In addition to these components, the component group 530 may include, for example, various components such as an acquisition component that acquires (downloads) an electronic file from the external system 130 and an OCR component that performs OCR processing on an electronic file.

Each of these components has a component common I/F 535. The component common I/F 535 is an API defined in common for the components, and includes an API for generating a component and an API for requesting the component to perform a process. Allowing the components to have the component common I/F 535 in this manner enables localization of an influence of addition of a component or the like. This can consequently reduce man-hours for development such as addition of a component.

The type conversion management unit 501 manages data type conversion for converting data serving as a processing target into data having a data format that can be processed by each component. The data type which each component can handle is determined in advance. Therefore, the type conversion management unit 501, for example, generates the type conversion definition/process 503 in response to a request from each component, and converts the data serving as the processing target into data having a format that can be processed by each component.

The type conversion definition/process 503 includes the type conversion common I/F 502 that is usable in common from the type conversion management unit 501. The type conversion common I/F 502 is an API defined in common for each type conversion definition/process 503. For example, the type conversion management unit 501 can request the type conversion definition/process 503 to perform or generate a type conversion process. The type conversion management unit 501, the type conversion common I/F 502, and the type conversion definition/process 503 are optional.

The logic processing unit 412 may be an information processing apparatus having the configuration of the computer 200. In this case, the logic processing unit 412 is an example of the service providing apparatus including the update control unit 512 and the execution control unit 511.

### Terminal Apparatus

The terminal apparatus 110 includes the browser (web browser) 401 implemented by a program executed by a CPU (for example, the CPU 301 or 201) of the terminal apparatus 110. A user of the terminal apparatus 110 uses the browser 401 to be able to use services provided by the service providing system 100.

### Authentication Server

The authentication server 120 is an authentication infrastructure corresponding to the external system 130. The example illustrated in FIG. 4 assumes the use of an external authentication system that supports an authentication scheme such as OAuth or OpenID, for example.

### External Component Service

The service providing system 100 may use the external component service 403 provided by another vender in addition to (or instead of) the document service unit 420 in the service providing system 100 to perform various processes on an electronic file. The external component service 403 includes the process executing unit 404 that performs various processes on an electronic file in response to a request from the service providing system 100.

Since the use of services outside the system is assumed in terms of the authentication server 120 and the external component service 403, detailed description is omitted herein.

### Process Flow

A process flow of a service providing method according to the first embodiment will be described next.

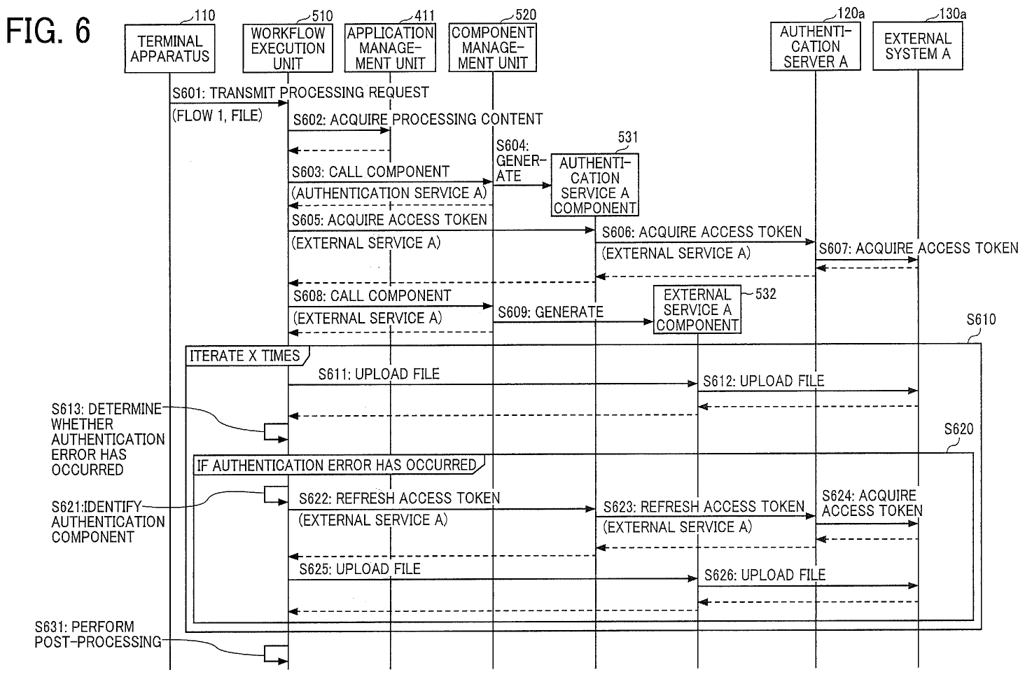

FIG. 6 is a sequence diagram illustrating an example of a process performed by the information processing system according to the first embodiment. This process is an example of a process for description, in which in response to a request from the terminal apparatus 110, the service providing system 100 acquires authentication information from the authentication server A 120a and uploads an electronic file to the external system A 130a X times.

In step S601, the browser 401 of the terminal apparatus 110 transmits a processing request for requesting execution of the process described above, to the workflow execution unit 510 of the service providing system 100. In response to the request, the information processing system 1 performs processing of step S602 and subsequent steps. The processing request transmitted by the browser 401 includes, for example, information for designating processing content (such as a workflow) and an electronic file or the like designated as a processing target by the processing content.

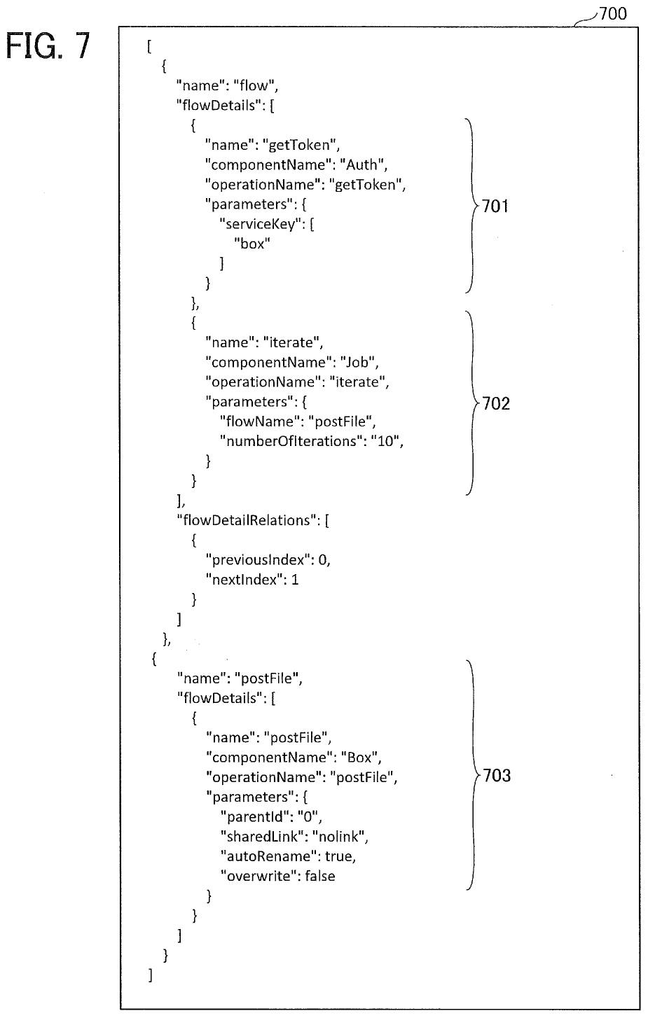

In step S602, in response to the processing request from the terminal apparatus 110, the execution control unit 511 of the workflow execution unit 510 acquires processing content designated by the processing request from the application management unit 411. For example, the execution control unit 511 acquires workflow information (an example of processing content) illustrated in FIG. 7 from the application management unit 411.

A broken-line arrow corresponding to a solid-line arrow in step S602 indicates a response message, an acknowledgement (ACK), or the like corresponding to the solid-line arrow. The same applies to the following processing.

FIG. 7 is a diagram illustrating an example of the workflow information according to the first embodiment. In the example illustrated in FIG. 7, in workflow information 700, an access token acquisition process 701 for acquiring an access token for the external system A 130a from the authentication server A 120a, an iteration process 702, and a file uploading process 703 are defined. The access token is an example of authentication information according to the present embodiment.

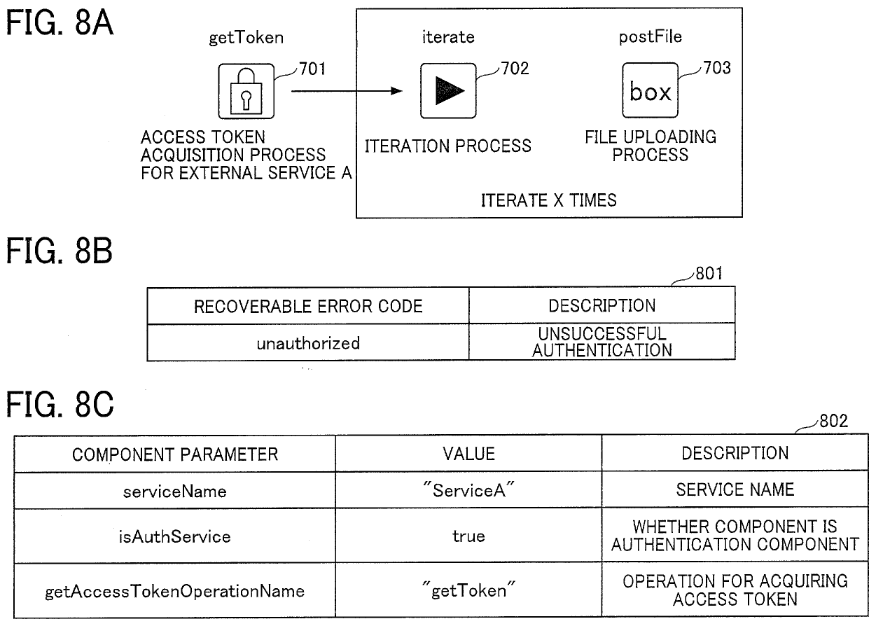

FIG. 8A schematically illustrates this workflow. In this workflow, the access token acquisition process 701 for the external service A is performed. Then, the iteration process 702 iterates the file uploading process 703X times (for example, 100 times). In such a process, a period of validity of the access token may expire while the execution control unit 511 of the workflow execution unit 510 iterates the file uploading process 703.

Referring back to FIG. 6, the description of the sequence diagram is continued. The execution control unit 511 of the workflow execution unit 510 controls processing of step S603 and subsequent steps in accordance with the acquired workflow information 700.

In step S603, the execution control unit 511 of the workflow execution unit 510 requests the component management unit 520 to call the authentication service A component 531. In response to this, in step S604, the component management unit 520 generates the authentication service A component 531. Consequently, as illustrated in FIG. 5, the authentication service A component 531 is generated in the component group 530. The execution control unit 511 now can request the authentication server A 120a to perform a process via the authentication service A component 531.

In steps S605 and S606, the execution control unit 511 of the workflow execution unit 510 uses the generated authentication service A component 531 to request the authentication server A 120a to acquire an access token for the external service A. In the present embodiment, a service provided by the external system A 130a is referred to as an “external service A”, and a service provided by the external system B 130b is referred to as an “external service B”. In response to this, in step S607, the authentication server A 120a acquires the access token for the external service A from the external system A 130a, and transmits the access token to the workflow execution unit 510.

In step S608, the execution control unit 511 of the workflow execution unit 510 requests the component management unit 520 to call the external service A component 532. In response to this, in step S609, the component management unit 520 generates the external service A component 532. Consequently, as illustrated in FIG. 5, the external service A component 532 is generated in the component group 530. The execution control unit 511 now can request the external system A 130a to perform a process via the external service A component 532 and the external service cooperating unit A 430a.

Subsequently to the processing described above, the execution control unit 511 of the workflow execution unit 510 iterates processing of S610 in FIG. 6 a predetermined number of times (X times) in accordance with the workflow information 700.

In steps S611 and S612, the execution control unit 511 of the workflow execution unit 510 uses the external service A component 532 and the external service cooperating unit A 430a to upload an electronic file to the external system A 130a.

In step S613, the update control unit 512 of the workflow execution unit 510 determines whether an authentication error has occurred in the processing of steps S611 and S612. For example, when an error occurs in the processing of steps S611 and S612 and the update control unit 512 is notified of a recoverable error code “unauthorized” stored in error code information 801 illustrated in FIG. 8B, the update control unit 512 determines that an authentication error has occurred.

If an authentication error has occurred, the update control unit 512 of the workflow execution unit 510 performs processing of S620 including steps S621 to S626. On the other hand, if no authentication error has occurred, the update control unit 512 does not perform (skips) the processing 620.

In step S621, the update control unit 512 of the workflow execution unit 510 identifies an authentication component which the update control unit 512 requests to refresh (update) the access token. For example, the update control unit 512 refers to the workflow information 700 illustrated in FIG. 7 and identifies the access token acquisition process 701 for the external service A. For example, the access token acquisition process 701 for the external service A has component information 802 illustrated in FIG. 8C. The update control unit 512 refers to such component information 802 to identify the access token acquisition process 701 for the external service A.

The 8C schematically illustrates an example of the component information 802 according to the first embodiment. The update control unit 512 refers a component parameter “isAuthService” in the component information 802 illustrated in FIG. 8C to be able to determine whether the component is an authentication component. The update control unit 512 also refers to a component parameter “serviceName” in the component information 802 to be able to determine whether the component is a component corresponding to the external service A (ServiceA). In this example, the update control unit 512 determines that the authentication component which the update control unit 512 requests to refresh (update) the access token is the authentication service A component 531 illustrated in FIG. 5.

In steps S622 and S623, the update control unit 512 of the workflow execution unit 510 uses the authentication service A component 531 to request the authentication server A 120a to refresh the access token for the external service A. In response to this, in step S624, the authentication server A 120a acquires an access token from the external system A 130a and transmits the acquired access token to the workflow execution unit 510.

In steps S625 and S626, the execution control unit 511 of the workflow execution unit 510 uses the updated access token to upload the electronic file to the external system A 130a.

The execution control unit 511 of the workflow execution unit 510 suspends execution of the workflow when performing the processing 620 including steps S621 to S626 in response to the occurrence of the authentication error in the file uploading process of steps S611 and S612. When the update control unit 512 completes updating the authentication information, the execution control unit 511 uses the updated authentication information to resume the execution of the workflow from the file uploading process in which the authentication error has occurred.

The file uploading process 703 is an example of a first process that is to be authenticated by the authentication server 120. The access token acquisition process 701 for the external service A is an example of a second process for acquiring authentication information corresponding to the first process.

In step S631, in response to the end of the processing 610, the execution control unit 511 of the workflow execution unit 510 performs post-processing.

Through the process described above, the logic processing unit 412 of the service providing system 100 can continue execution of a workflow even if an authentication error occurs during the execution of the workflow.

### Second Embodiment

In a second embodiment, description will be given of an example of a process performed in the case where the logic processing unit 412 of the service providing system 100 acquires authentication information from the plurality of authentication servers 120.

### Functional Configuration of Logic Processing Unit

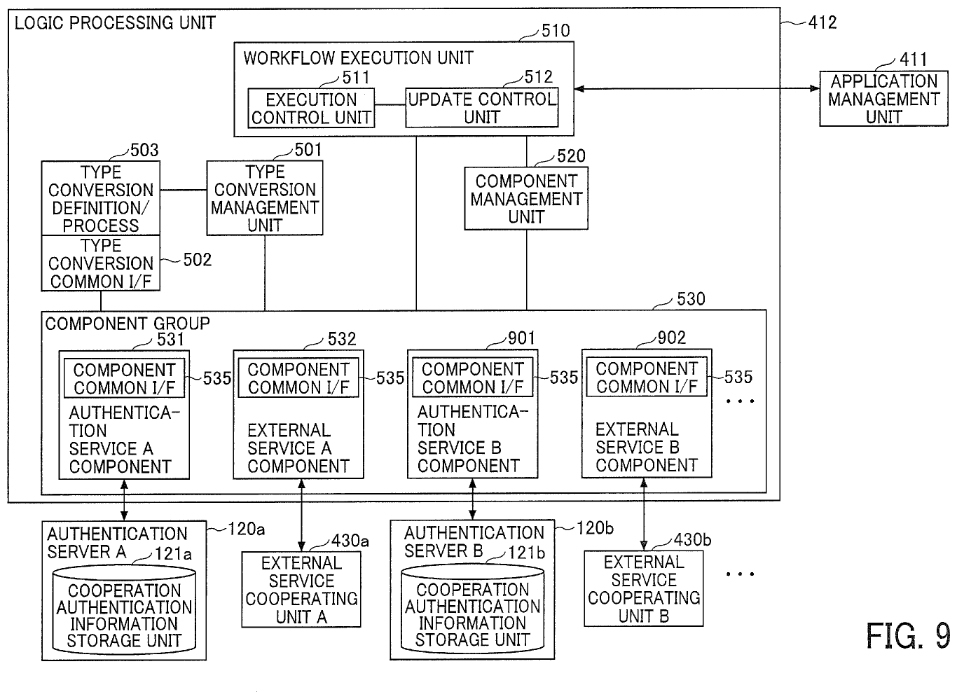

FIG. 9 is a block diagram illustrating an example of a functional configuration of the logic processing unit 412 according to the second embodiment. As illustrated in FIG. 9, the logic processing unit 412 according to the second embodiment has substantially the same functional configuration as the logic processing unit 412 according to the first embodiment described with reference to FIG. 5. However, the component group 530 of the logic processing unit 412 according to the second embodiment further includes an authentication service B component 901 and an external service B component 902.

### Process Flow

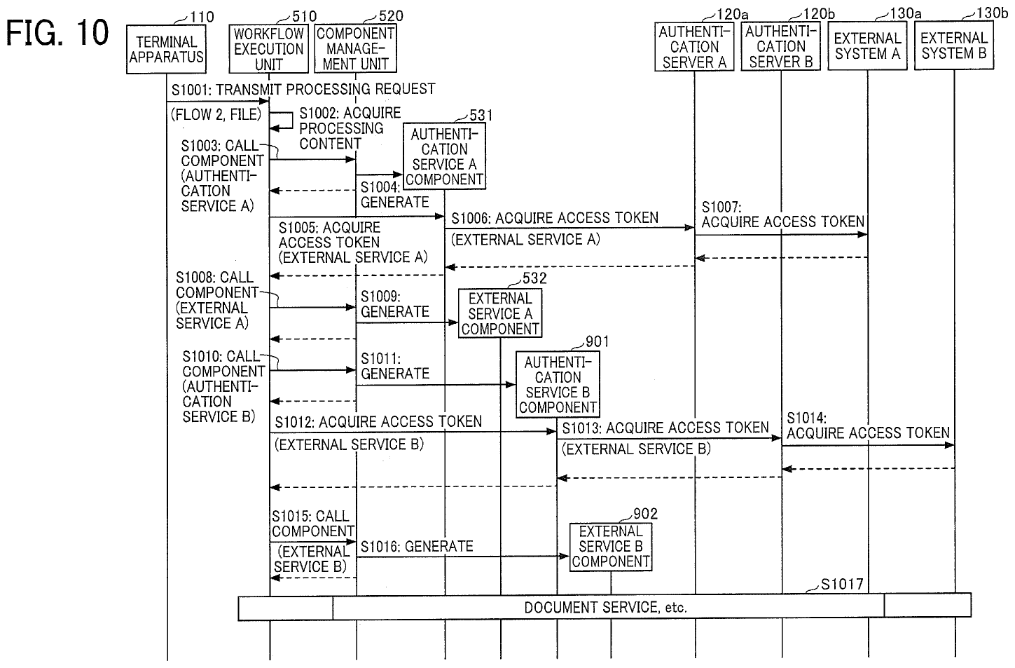

FIG. 10 is a sequence diagram illustrating an example of a process performed by the information processing system according to the second embodiment. Detailed description of processing that is substantially the same as that of the first embodiment is omitted herein.

In step S1001, the browser 401 of the terminal apparatus 110 transmits a processing request for requesting execution of a process to the workflow execution unit 510 of the service providing system 100. In response to this, the information processing system 1 performs processing of step S1002 and subsequent steps.

In step S1002, in response to the processing request from the terminal apparatus 110, the execution control unit 511 of the workflow execution unit 510 acquires processing content designated by the processing request from the application management unit 411. It is assumed that the execution control unit 511 acquires workflow information including a process for acquiring access tokens from the authentication servers A 120a and B 120b.

In step S1003, the execution control unit 511 of the workflow execution unit 510 requests the component management unit 520 to call the authentication service A component 531. In response to this, in step S1004, the component management unit 520 generates the authentication service A component 531. Consequently, the authentication service A component 531 is generated in the component group 530 as illustrated in FIG. 9.

In steps S1005 and S1006, the execution control unit 511 of the workflow execution unit 510 uses the generated authentication service A component 531 to request the authentication server A 120a to acquire an access token for the external service A. In response to this, in step S1007, the authentication server A 120a acquires an access token for the external service A from the external system A 130a and transmits the acquired access token to the workflow execution unit 510.

In step S1008, the execution control unit 511 of the workflow execution unit 510 requests the component management unit 520 to call the external service A component 532. In response to this, in step S1009, the component management unit 520 generates the external service A component 532. Consequently, the external service A component 532 is generated in the component group 530 as illustrated in FIG. 9.

In step S1010, the execution control unit 511 of the workflow execution unit 510 requests the component management unit 520 to call the authentication service B component 901. In response to this, in step S1011, the component management unit 520 generates the authentication service B component 901. Consequently, the authentication service B component 901 is generated in the component group 530 as illustrated in FIG. 9.

In steps S1012 and S1013, the execution control unit 511 of the workflow execution unit 510 uses the generated authentication service B component 901 to request the authentication server B 120b to acquire an access token for the external service B. In response to this, in step S1014, the authentication server B 120b acquires an access token for the external service B from the external system B 130b and transmits the acquired access token to the workflow execution unit 510.

In step S1015, the execution control unit 511 of the workflow execution unit 510 requests the component management unit 520 to call the external service B component 902. In response to this, in step S1016, the component management unit 520 generates the external service B component 902. Consequently, the external service B component 902 is generated in the component group 530 as illustrated in FIG. 9.

In step S1017, the execution control unit 511 of the workflow execution unit 510 executes a document service or the like defined in the workflow.

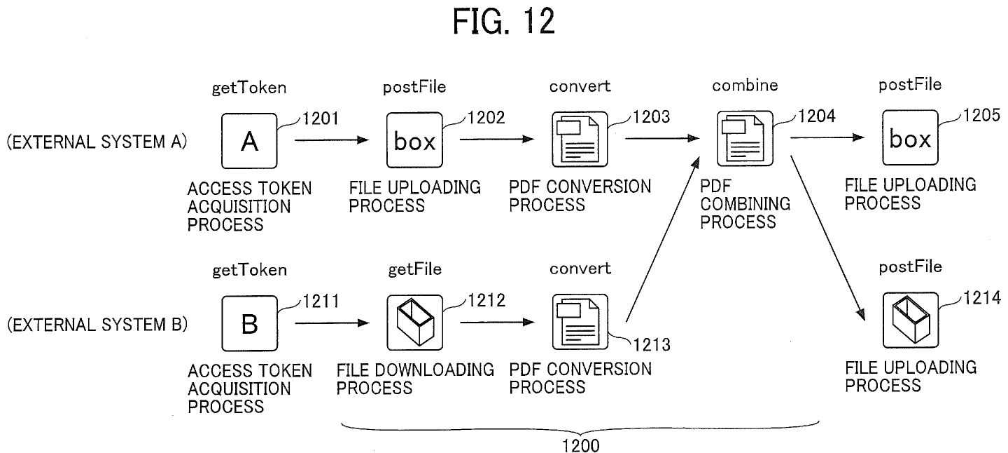

FIG. 12 is a schematic diagram for describing an example of a workflow according to the second embodiment. In the example illustrated in FIG. 12, according to the workflow, an access token acquisition process 1201, a file uploading process 1202, a PDF conversion process 1203, a PDF combining process 1204, and a file uploading process 1205 are to be performed in the external system A 130a. According to the workflow, an access token acquisition process 1211, a file downloading process 1212, a PDF conversion process 1213, and a file uploading process 1214 are to be performed in the external system B 130b.

In step S1017 illustrated in FIG. 10, it is assumed that the execution control unit 511 of the workflow execution unit 510 performs, for example, a process 1200 among the processes illustrated in FIG. 12. The process 1200 includes the file uploading process 1202, the PDF conversion process 1203, and the PDF combining process 1204 that are performed by the external system A 130a, and the file downloading process 1212 and the PDF conversion process 1213 that are performed by the external system B 130b. In such a process 1200, for example, if an electronic file subjected to the PDF conversion processes 1203 and 1213 and the PDF combining process 1204 has many pages, the period of validity of the access token may expire during execution of the process 1200.

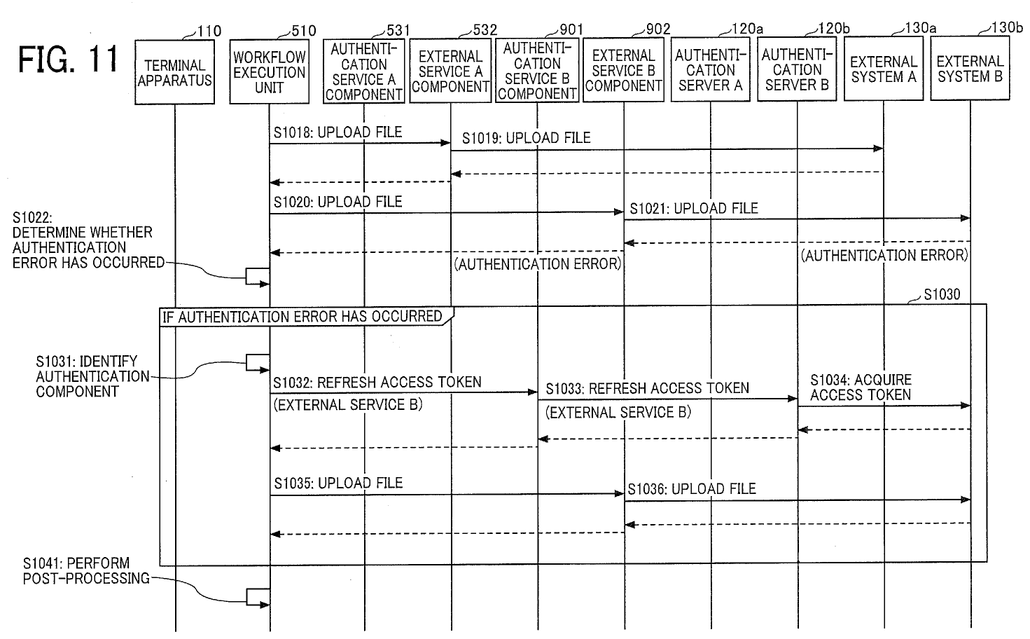

For example, after performing a document service such as the process 1200 in step S1017 illustrated in FIG. 10, the information processing system 1 performs processing of step S1018 and subsequent steps illustrated in FIG. 11.

In steps S1018 and S1019, the execution control unit 511 of the workflow execution unit 510 uses the external service A component 532 and the external service cooperating unit A 430a to upload an electronic file to the external system A 130a. This processing corresponds to, for example, the file uploading process 1205 illustrated in FIG. 12.

In steps S1020 and S1021, the execution control unit 511 of the workflow execution unit 510 uses the external service B component 902 and the external service cooperating unit B 430b to upload the electronic file to the external system B 130b. This processing corresponds to, for example, the file uploading process 1214 illustrated in FIG. 12. As an example for description, it is assumed that an authentication error occurs because of expiration of the period of validity of the access token in steps S1020 and S1021.

In step S1022, the update control unit 512 of the workflow execution unit 510 determines whether an authentication error has occurred in the processing of step S1018 to S1021. If an authentication error has occurred in the external system B 130b, the update control unit 512 of the workflow execution unit 510 performs processing of S1030 including steps S1031 to S1036. On the other hand, if no authentication error has occurred, the update control unit 512 skips the processing 1030. If an authentication error has occurred in the external system A 130a, the update control unit 512 performs, for the external system A 130a, processing (for example, the processing 620 illustrated in FIG. 6) that is substantially the same as the processing of S1030 including steps S1031 to S1036.

In step S1031, the update control unit 512 of the workflow execution unit 510 identifies an authentication component which the update control unit 512 requests to refresh (update) the access token. For example, the update control unit 512 refers to the workflow information acquired in step S1002 and identifies an authentication component (the authentication service B component 901) which acquires an access token for the external system B 130b and for which the authentication error has occurred.

In steps S1032 and S1033, the update control unit 512 of the workflow execution unit 510 uses the authentication service B component 901 to request the authentication server B 120b to refresh the access token for the external service B. In response to this, in step S1034, the authentication server B 120b acquires an access token from the external system B 130b and transmits the acquired access token to the workflow execution unit 510.

In steps S1035 and S1036, the execution control unit 511 of the workflow execution unit 510 uses the updated access token to upload the electronic file to the external system B 130b.

Through the processing 1030 described above, the execution control unit 511 of the workflow execution unit 510 suspends execution of the workflow in response to the occurrence of the error in the file uploading process 1214 and resumes the execution of the workflow upon the update control unit 512 completing updating of the authentication information.

In step S1041, the execution control unit 511 of the workflow execution unit 510 performs post-processing.

Through the process described above, the service providing system 100 is able to continue execution of a workflow that acquires authentication information from the plurality of authentication servers 120 even if an authentication error occurs during the execution of the workflow.

### Third Embodiment

In the first and second embodiments, when a workflow includes a process that is to be authenticated by the authentication server 120, an access token acquisition process for the process is defined in the workflow. In a third embodiment, description will be given of an example of the case where the service providing system 100 has a default authentication server or information on the default authentication server.

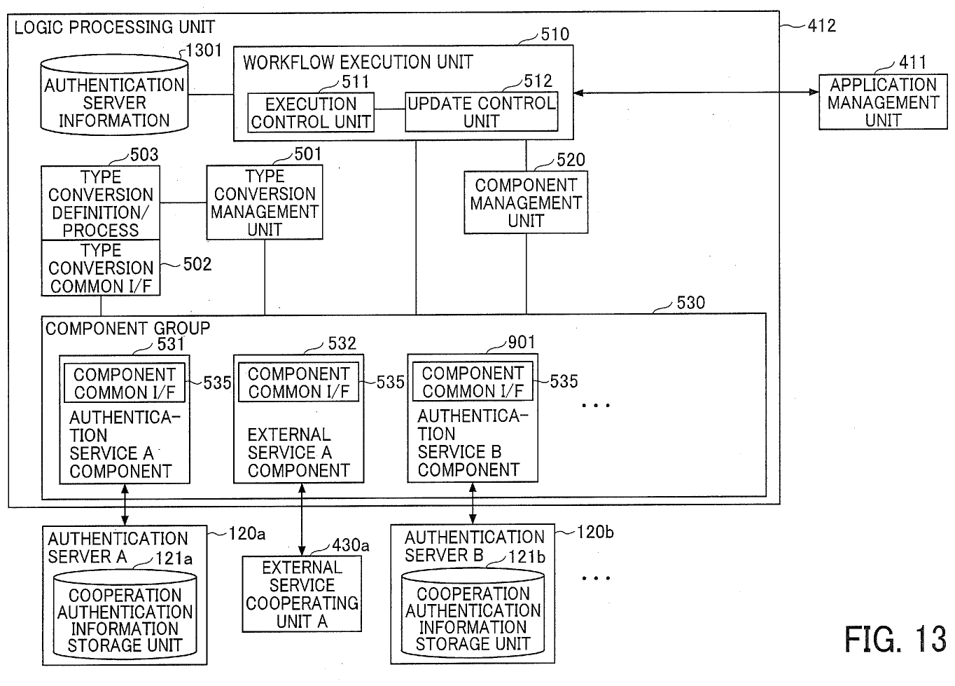

FIG. 13 is a block diagram illustrating an example of a functional configuration of the logic processing unit according to the third embodiment. FIG. 13 illustrates an example of the functional configuration of the logic processing unit 412 in the case where the service providing system 100 includes authentication server information 1301 in which information on a default authentication server 120 is stored in advance.

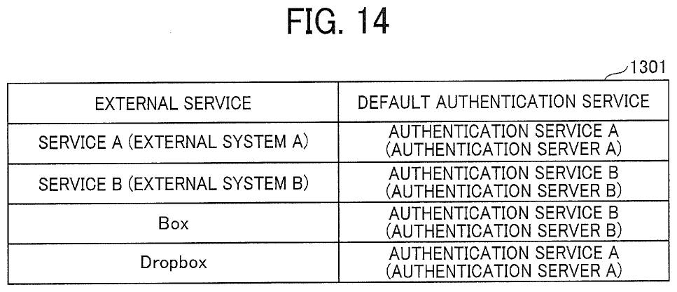

FIG. 14 schematically illustrates an example of the authentication server information 1301 according to the third embodiment. As illustrated in FIG. 14, for each external service (or for each external system 130), information on the corresponding authentication service (or the corresponding authentication server 120) is stored in advance in the authentication server information 1301. Based on this authentication server information 1301, the update control unit 512 of the workflow execution unit 510 can identify the default authentication server 120 for each external system 130.

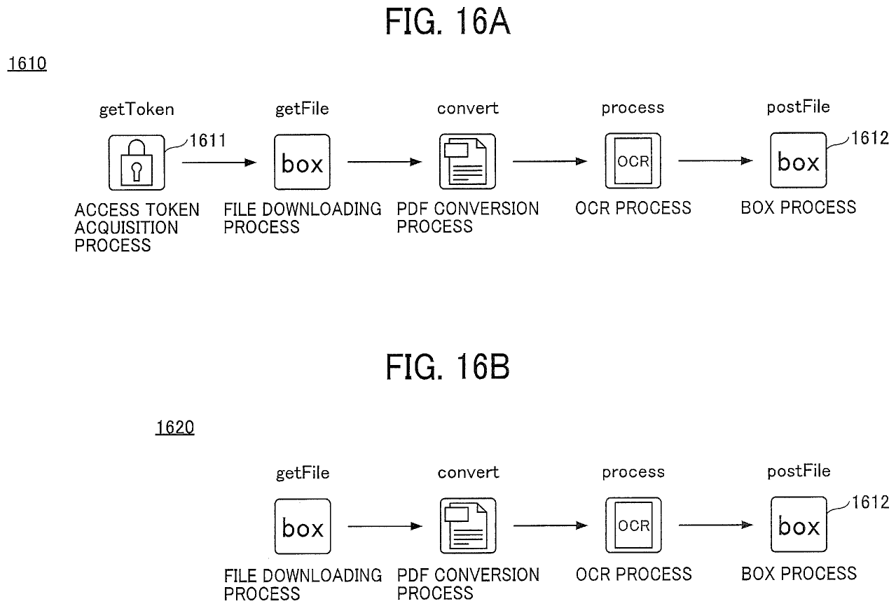

FIG. 16A illustrates an example of the case where a workflow 1610 includes an access token acquisition process 1611 corresponding to a process (a box process 1612) that is to be authenticated by the authentication server 120. In this case, in response to an occurrence of an authentication error in the box process 1612, the update control unit 512 according to the third embodiment identifies the authentication server 120 that refreshes the access token in substantially the same manner as in the first and second embodiments, for example.

FIG. 16B illustrates an example of the case where a workflow 1620 does not include the access token acquisition process 1611 corresponding to the process (the box process 1612) that is to be authenticated by the authentication server 120. In this case, in response to an occurrence of an authentication error in the box process 1612, the update control unit 512 according to the third embodiment refers to the authentication server information 1301 and identifies the authentication service B (the authentication server B 120b) corresponding to the box process 1612.

In this manner, the service providing system 100 according to the third embodiment can omit, from the workflow, description of the access token acquisition process for the process that uses the default authentication server 120.

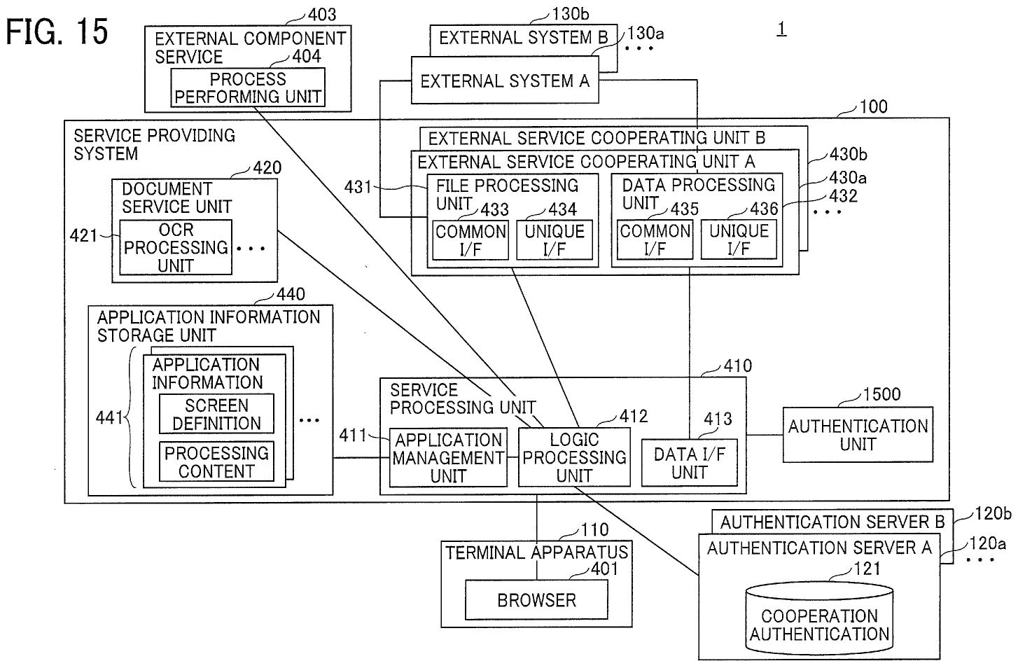

FIG. 15 illustrates an example of a functional configuration of the information processing system according to the third embodiment. In the example illustrated in FIG. 15, the service providing system 100 includes an authentication unit 1500, which is a default authentication server, in the service providing system 100. In such a case, the service providing system 100 may set the authentication unit 1500 as the default authentication server. In this case, the logic processing unit 412 need not include the authentication server information 1301.

In this case, for example, in response to an occurrence of an authentication error in the box process 1612 in the workflow 1620 illustrated in FIG. 16B, the update control unit 512 identifies the authentication unit 1500 of the service providing system 100 as the authentication service corresponding to the box process 1612.

Also in this case, description of the access token acquisition process may be omitted, from the workflow, for the process that uses the default authentication server 120 in the service providing system 100.

As described above, according to each of the embodiments of the present disclosure, the service providing system 100 capable of changing an authentication service for processes included in a workflow is able to continue execution of the workflow even if an authentication error occurs during the execution of the workflow.

Each of the functions of the above-described embodiments may be implemented by one or more pieces of processing circuitry. The term “processing circuitry” used herein refers to a processor that is programmed to carry out each function by software such as a processor implemented by an electronic circuit, or a device such as an ASIC, digital signal processor (DSP), field programmable gate array (FPGA), or existing circuit module that is designed to carry out each function described above.

The apparatuses or devices described in the embodiments are merely an example of a plurality of computing environments for implementing the embodiments disclosed herein. In some embodiments, the service providing system includes a plurality of computing devices such as a server cluster. The plurality of computing devices communicate with each other via a communication link of any type including a network, shared memory, or the like and perform the processes disclosed herein. Likewise, the service processing unit 410 can include a plurality of computing devices that communicate with each other. The components of the service providing system 100 may be collected in a single server apparatus or may be distributed to a plurality of apparatuses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A service providing system comprising:
circuitry configured to
control execution of a workflow defining a plurality of processes,
in response to an occurrence of an authentication error in a first process authenticated by an authentication server among the plurality of processes of the workflow, control updating of authentication information corresponding to the first process, while suspending the execution of the workflow, and
resume the execution of the workflow based on completion of the updating of the authentication information.

2. The service providing system according to claim 1, wherein in a case where the workflow includes a second process for acquiring the authentication information corresponding to the first process, the circuitry updates the authentication information using the second process.

3. The service providing system according to claim 2, wherein in a case where the workflow does not include the second process for acquiring the authentication information corresponding to the first process, the circuitry updates the authentication information using a default authentication server.

4. The service providing system according to claim 3, wherein
the first process includes one or more first processes authenticated by one or more authentication servers, and
the service providing system further comprises:
authentication server information that stores information on a default authentication server for each of the one or more first processes.

5. The service providing system according to claim 1, wherein the first process includes a process performed by an external system that is external to the service providing system.

6. The service providing system according to claim 2, wherein the second process includes a process for requesting an authentication server that is external to the service providing system to perform authentication.

7. The service providing system according to claim 1, wherein
the authentication information corresponding to the first process includes an access token, and
the circuitry
updates the access token in response to expiration of a period of validity of the access token, and
resumes the execution of the workflow from the first process using the updated access token.

8. A service providing apparatus comprising:
circuitry configured to
control execution of a workflow defining a plurality of processes,
in response to an occurrence of an authentication error in a first process authenticated by an authentication server among the plurality of processes of the workflow, control updating of authentication information corresponding to the first process, while suspending the execution of the workflow, and
resume the execution of the workflow based on completion of the updating of the authentication information.

9. A service providing method comprising:
controlling execution of a workflow defining a plurality of processes;
in response to an occurrence of an authentication error in a predetermined process authenticated by an authentication server among the plurality of processes of the workflow, controlling updating of authentication information corresponding to the predetermined process, while suspending the execution of the workflow; and
resuming the execution of the workflow based on completion of the updating of the authentication information.
